(19) United States
(12) Patent Application Publication
(10) Pub. No.: US 2024/0256897 A1
(43) Pub. Date: Aug. 1, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Yujiro SOEDA, Kanagawa (JP)

(21) Appl. No.: 18/422,116

(22) Filed: Jan. 25, 2024

(30) Foreign Application Priority Data
Jan. 31, 2023 (JP) 2023-013284

(51) Int. Cl. G06N 3/098; G06V 10/776

(52) U.S. Cl. CPC G06N 3/098; G06V 10/776

(57) ABSTRACT

There is provided with an information processing apparatus. A performing unit performs, for each of a plurality of recognition models that perform different recognition tasks, learning using corresponding learning data. A reconstructing unit reconstructs, during the learning, the plurality of recognition models by replacing weight parameters respectively acquired by shared parts of the recognition models with an integrated parameter obtained by integrating the weight parameters. A setting unit sets, during the learning, an integration cycle for performing the integration.

### BACKGROUND OF THE INVENTION

### Field of the Invention

The present invention relates to an information processing apparatus, an information processing method, and a storage medium.

### Description of the Related Art

Technologies for recognizing objects in images have been applied to the functions of image capturing apparatuses such as digital cameras. Here, the object of recognition processing is called a recognition task, and the mathematical model for learning and executing the recognition task is called a recognition model. An example of a recognition task is a face detection task for detecting regions of human faces from images. There is a diversity of other recognition tasks such as an object category recognition task for determining the category (human, animal, vehicle, etc.) of objects (subjects) in images, a tracking task for searching for and tracking specific subjects, and a scene type recognition task for determining types of scenes (city, mountain, ocean, etc.).

Neural networks (NN) are known as a technology for realizing such recognition tasks. There is a type of neural network with a large number of layers or deep layers called a deep neural network (DNN). In particular, one type of deep neural network that performs convolutions is called a deep convolutional neural network (DCNN). In recent years, DCNNs have attracted attention for their high-performance recognition processing.

A DCNN has a network structure in which, in each layer, convolution processing is performed on the output from the previous layer and the processing result is output to the next layer. The final layer of the DCNN is an output layer that represents the recognition result. A plurality of filters (kernels) for use in convolutional operations are provided in each layer. The layer close to the output layer generally has the structure of a fully connected layer like a normal NN rather than being connected by convolutions. The filters used in the convolutional operations will be referred to as convolutional filters in the following description.

In the learning phase of recognition models of the DCNN, the values of the convolutional filters and the connection weights of the fully connected layer are learned from supervised data using a method such as backpropagation (BP). In the recognition phase of the DCNN, data is input to the DCNN that has completed learning, the data is sequentially processed by the recognition model that has completed learning in each layer, and a recognition result is obtained from the output layer.

Sharing of some of the values of the convolutional filters or the weights of the fully connected layers by a plurality of recognition tasks that are processed is called multitask recognition, and the learning method thereof is called multitask learning. In multitasking learning, technologies that enable efficient learning so as to improve the recognition performance of a plurality of recognition tasks have been actively discussed. For example, Japanese Patent Laid-Open No. 2019-192009 discloses a technology for efficiently performing learning by setting learning parameters based on evaluation results of the recognition models corresponding to the recognition tasks. Here, learning parameters include the magnitude of the learning rate of the learning of a multilayer NN and the loss ratio that is calculated for each recognition task at the time of learning. Also, Japanese Patent No. 6750854 discloses a technique that is able to efficiently search for a suitable NN structure in a plurality of multilayer NNs that execute a plurality of tasks.

On the other hand, there is a method of efficiently performing learning of a multilayer NN that involves using distributed learning (e.g., “Multitask learning”, Caruana, R, Machine learning 28, 1997, pp. 41-75). Distributed learning is a technique that uses a plurality of computation nodes connected via a communication network to perform deep learning distributed among the plurality of computation nodes. In distributed learning, communication is mainly performed in order to compute the average, for all the computation nodes, of the gradients computed by the computation nodes or the weights of the recognition models. Distributed learning is generally used in order to speed up the learning of a single task, but can also be applied to multitasking learning. For example, it is conceivable that the recognition tasks are each allocated one computation node and are independently learned in parallel, and that the weights of the shared layers of the recognition models are integrated and updated between the nodes at a predetermined frequency.

### SUMMARY OF THE INVENTION

According to one embodiment of the present invention, an information processing apparatus comprises one or more memories storing instructions and one or more processors that execute the instructions to: perform, for each of a plurality of recognition models that perform different recognition tasks, learning using corresponding learning data; reconstruct, during the learning, the plurality of recognition models by replacing weight parameters respectively acquired by shared parts of the recognition models with an integrated parameter obtained by integrating the weight parameters; and set, during the learning, an integration cycle for performing the integration.

According to another embodiment of the present invention, an information processing method comprises: performing, for each of a plurality of recognition models that perform different recognition tasks, learning using corresponding learning data; reconstructing, during the learning, the plurality of recognition models by replacing weight parameters respectively acquired by shared parts of the recognition models with an integrated parameter obtained by integrating the weight parameters; and setting, during the learning, an integration cycle for performing the integration.

According to yet another embodiment of the present invention, a non-transitory computer readable storage medium stores a program that, when executed by a computer, causes the computer to perform an information processing method comprising: performing, for each of a plurality of recognition models that perform different recognition tasks, learning using corresponding learning data; reconstructing, during the learning, the plurality of recognition models by replacing weight parameters respectively acquired by shared parts of the recognition models with an integrated parameter obtained by integrating the weight parameters; and setting, during the learning, an integration cycle for performing the integration.

Further features of the present invention will become apparent from the following description of exemplary embodiments (with reference to the attached drawings).

### BRIEF DESCRIPTION OF THE DRAWINGS

FIG. 1 is a block diagram showing an example of a functional configuration of an information processing apparatus according to a first embodiment.

FIG. 2 is a diagram for describing learning data according to the first embodiment.

FIG. 3 is a diagram for describing distributed learning processing according to the first embodiment.

FIG. 4 is a block diagram showing an example of the functional configuration of an information processing apparatus according to a second embodiment.

FIG. 5 is a diagram for describing distributed learning processing according to the second embodiment.

FIG. 6 is a block diagram showing an example of the functional configuration of an information processing apparatus according to a third embodiment.

FIG. 7 is a diagram for describing the distributed learning processing according to the third embodiment.

FIG. 8 is a schematic diagram for describing distributed learning according to the first embodiment.

FIG. 9 is a schematic diagram for describing distributed learning according to the second embodiment.

FIG. 10 is a schematic diagram for describing distributed learning according to the third embodiment.

FIG. 11 is a flowchart showing an example of distributed learning processing according to the first embodiment.

FIG. 12 is a block diagram showing an example of a hardware configuration of the information processing apparatus according to the first embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

In the case of performing a multitask distributed learning method, there is a problem in that a difference in recognition accuracy may arise between recognition tasks, due to factors such as a difference in the characteristics of the recognition tasks and a difference in the amounts of learning data of the recognition tasks. A camera provided with a detector in which there is a difference in recognition accuracy between the recognition tasks will greatly impair the user experience.

Furthermore, it is known that when distributed learning is continuously performed, the weights of the shared layers may deteriorate to local solutions, and further learning may only result in small changes in the weights. For example, consider the case where integration of the shared layers of recognition models is realized by weighted average. Normally, when there is a difference in recognition accuracy between recognition tasks, weights of the shared layers with which the difference in accuracy is reduced are obtained if the weights are integrated while distinguishing between the weighted average weight values. However, weights of the shared layers of the recognition models with which the difference in accuracy between recognition tasks is reduced are not obtained even if the weighted average is taken in a state where the changes in the weights of the shared layers are small as aforementioned.

The embodiments of the present invention provide an information processing apparatus for suppressing the occurrence of a difference in recognition accuracy between a plurality of recognition tasks in multitask learning for learning the recognition tasks.

### First Embodiment

In the first embodiment, a plurality of mathematical models (recognition models) that learn and execute the objects (recognition tasks) of recognition processing partially include neural networks having the same layer structure. The portions of the neural networks having the same layer structure will henceforth be referred to as shared layers or shared parts. The recognition models then separately learn the weights (henceforth, also referred to as “weight parameters” or “weight parameters for use in characteristic operations”) and, thereafter, at a timing described later, distributed learning is performed in which the weights of the shared parts are integrated. Such distributed learning becomes possible because the recognition models have shared layers. Hereinafter, two recognition models will be used as a plurality of recognition models for which learning is performed by an information processing apparatus according to the present embodiment, with the recognition models being referred to as recognition models A and B, and the recognition tasks respectively corresponding thereto being referred to as recognition tasks A and B. However, the number or type of recognition models and recognition tasks are not limited thereto, and three or more of each may be used. Also, the recognition targets of the recognition tasks may differ from each other or the same tasks may be included.

An information processing apparatus 1 according to the present embodiment performs learning using corresponding learning data, for each of the plurality of recognition models that perform different recognition tasks. Next, the information processing apparatus 1 reconstructs the plurality of recognition models during learning, by replacing weight parameters respectively acquired by the shared parts of the recognition models with an integrated parameter obtained by integrating the weight parameters. The integration cycle at which integration is performed is set during learning.

Note that the information processing apparatus 1 according to the present embodiment is able to evaluate the recognition accuracies of the recognition models with respect to the different recognition tasks and set the integration cycle based on the difference in evaluations of the recognition accuracies between the recognition models. A detailed description of such evaluations of recognition accuracies will be given later.

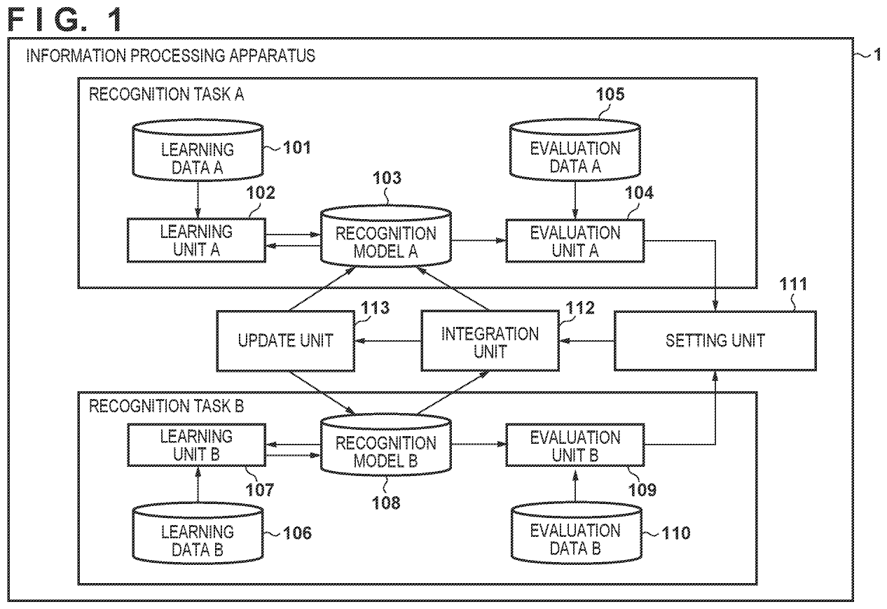

FIG. 1 is a block diagram showing an example of the functional configuration of the information processing apparatus 1 according to the present embodiment. The information processing apparatus 1 performs distributed learning that uses the recognition model A corresponding to the recognition task A and the recognition model B corresponding to the recognition task B. The information processing apparatus 1 includes a learning unit A102, a recognition model A103 and an evaluation unit A104 corresponding to the recognition model A and a learning unit B107, a recognition model B108 and an evaluation unit B109 corresponding to the recognition model B. Also, the information processing apparatus 1 includes a setting unit 111, an integration unit 112 and an update unit 113.

In the present embodiment, the recognition targets to be recognized by the recognition tasks are not particularly limited. Here, for convenience of description, the recognition task A will be described as an automobile detection task for detecting an automobile, and the recognition task B will be described as a motorcycle detection task for detecting a motorcycle. Here, two models, namely, the recognition model A and the recognition model B, are illustrated for convenience of description, but, as described above, the information processing apparatus 1 may perform learning and integration for three or more recognition tasks.

The learning unit A102 performs learning of the recognition model A103, using learning data A101 for learning the recognition task A (automobile detection). Hereinafter, recognition models including the recognition models A and B are constituted by a multilayer neural network (NN), and output the recognition results of recognition targets with respect to inputs such as images or feature values. Learning by a multilayer NN that performs recognition of a recognition target can be performed with a known technology, and a detailed description thereof is omitted.

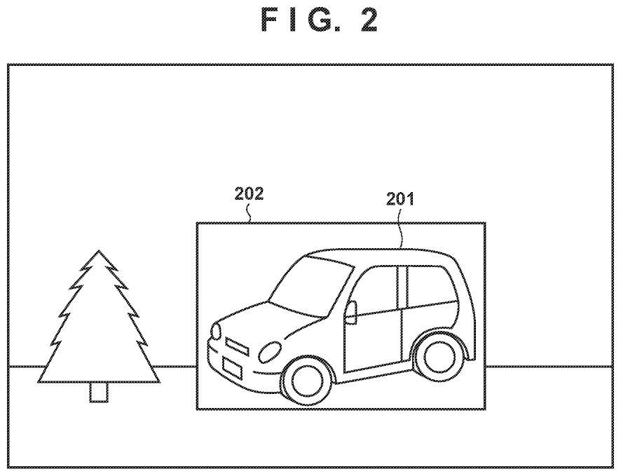

The learning data A101 includes a learning image for use in learning the recognition task A and correct answer data corresponding to the learning image. An example of a learning image and correct answer data is shown in FIG. 2. In FIG. 2, an automobile 201 serving as a detection target of the recognition task A appears in the learning image which is an image that is used in learning. Also, in this example, the position (e.g., center coordinates) of a bounding box 202 surrounding the automobile 201 and the width and height thereof are correct answer data.

The evaluation unit A104 is able to evaluate the recognition accuracy of the recognition model A103, using evaluation data A105. The evaluation data A105 has the same configuration as the learning data A101 in terms of being constituted by a learning image and correct answer data, but the learning image included in the evaluation data A105 is different from the image included in the learning data A101. The evaluation unit A104 according to the present embodiment evaluates the recognition accuracy and transmits an evaluation result to the setting unit 111.

For example, the evaluation unit A104 is able to evaluate the recognition accuracy at the timing at which the weights of the shared parts are integrated (timing at which learning is performed enough times for the weights to be integrated). In the present embodiment, the integration cycle for performing integration is set by the setting unit 111 during learning, and thus the timing of evaluation of the recognition accuracy by the evaluation unit A104 also varies during learning according to the integration cycle setting. However, the evaluation timing is not limited thereto, and can be freely set according to desired conditions, such as a fixed cycle set in advance, for example. In the case where the evaluation unit A104 evaluates the recognition accuracy at a fixed cycle, the setting unit 111 described later sets the integration cycle of the next integration, using the result of the evaluation of recognition accuracy performed at the closest timing to when the integration of the shared parts by the integration unit 112 is performed. Processing by the information processing apparatus 1 according to the present embodiment will be described later. The cycle for performing evaluation by the evaluation unit A104 according to the present embodiment is set using the number of learning iterations or a learning time period.

The evaluation unit A104 is able to compare the output result of the recognition task that is executed after inputting the learning image included in the evaluation data A105 to the recognition model A103 with the correct answer data included in the evaluation data A105, and calculate (an evaluation value of) the recognition accuracy thereof. As the recognition accuracy according to the present embodiment, it is possible to use any comparable scale that represents the accuracy of the recognition processing, such as the accuracy rate, recall or precision for the evaluation data of the detected region, for example. In the following, description will be given assuming that the recall of the detected region is used as the recognition accuracy.

Since the learning unit B107, the recognition model B108 and the evaluation unit B109 of the recognition task B can perform processing similarly to the learning unit A102, the recognition model A103 and the evaluation unit A104, except for the recognition task being different, redundant description will be omitted. Similarly, the learning data B106 and the evaluation data B110 are basically constituted similarly to the learning data A101 and the evaluation data A105 except for the recognition target being different.

The setting unit 111 sets the integration cycle for integrating weights corresponding to the shared parts during learning. As described above, the setting unit 111 according to the present embodiment is able to evaluate the recognition accuracies of the recognition models with respect to the different recognition tasks, and to set the integration cycle based on the difference in evaluations of the recognition accuracies between the recognition models.

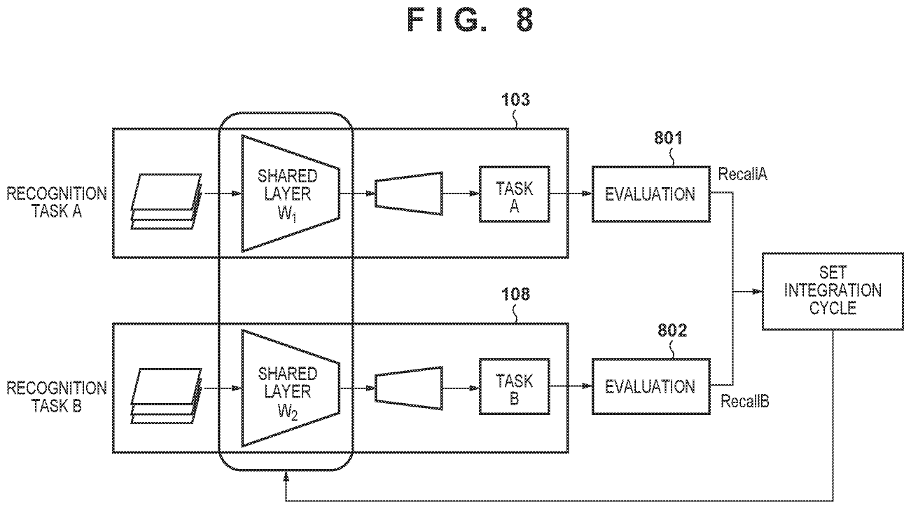

FIG. 8 is a schematic diagram of an example of integration cycle setting processing that is performed by the information processing apparatus 1 according to the present embodiment. In FIG. 8, the evaluation unit A104 and the evaluation unit B109 output evaluation values for the respective recognition tasks, for the recognition model A and the recognition model B during learning. Here, the evaluation of the recognition task A is output as an evaluation 801 (Recall_{A}), and the evaluation of the recognition task B is output as an evaluation 802 (Recall_{B}). The setting unit 111 sets the integration cycle based on these evaluations (e.g., based on an Equation (1) described later), and replaces the shared layers (here, W₁, W₂) of the respective recognition models with a shared layer after integration at the set integration cycle.

Hereinafter, the integration cycle setting processing that is performed by the setting unit 111 will be described. Note that “integration cycle” here refers to the integration cycle set by the setting unit 111 at which weights corresponding to the shared parts are integrated.

The evaluation unit A104 and the evaluation unit B109 (hereinafter, may be simply referred to as “evaluation units” without distinguishing therebetween) are able to calculate the recalls Recall_{A} and Recall_{B} as the recognition accuracies of the respective recognition models. Recall according to the present embodiment is the recognition accuracy represented by a percentage that the detection target can be correctly detected in a group of images in which the detection target appears. The evaluation units may calculate the recall based on the learning result of the recognition models at the time of evaluation, or may calculate the recall by inputting a predetermined number of images into the respective recognition models and causing the recognition models to perform detection in order to calculate the recall. Since calculation of recall is a known technology, a detailed description thereof will be omitted.

The setting unit 111 is able to lengthen the integration cycle in the case where the difference in the recognition accuracies of the recognition models exceeds a predetermined threshold. For example, the setting unit 111 sets the integration cycle for integration of the weights corresponding to the shared parts of the recognition model A103 and the recognition model B108 by the integration unit 112, based on the following Equation (1) that uses recall calculated by the evaluation units. Note that, here, the integration cycle is the number of learning iterations.

$$\\ \begin{matrix}{T}_{n} = \{ \begin{matrix}{T}_{n - 1} + k , \vert {Recall}_{A} - {Recall}_{B} \vert > TH \\ {T}_{n - 1} , otherwise\end{matrix} & ( 1 )\end{matrix}$$

In Equation (1), Recall_{A} is the most recent recall (e.g., at 1000 iterations) of the recognition task A, Recall_{B} is the recall at the time of the most recent integration of the recognition task B, TH is a threshold, k is an increase in the integration cycle. Also, Tₙ is the integration cycle that is set this time (nth iteration), and Tₙ₋₁ is the integration cycle set last time. ∥ is a sign representing absolute value. Here, the threshold TH is a value freely determined by the user that implements learning. The increase k in the integration cycle is a value freely determined by the user that implements learning. The integration cycle at the time of performing the initial evaluation, that is, the integration cycle T₀ at n=0, is also a value freely determined by the user that implements learning.

When the difference in the recalls with respect to the recognition tasks is large, one of the recognition tasks is performed poorly (recognition accuracy with respect to the recognition task is low) relative to the other recognition task. It is conceivable that if distributed learning is continued in this state, the recognition accuracy with respect to the recognition task that is not performed poorly will improve, whereas the recognition accuracy with respect to the recognition task that is performed poorly will not improve comparatively, resulting in a difference in recognition accuracy opening up between the recognition tasks. In view of this, by lengthening the learning period (hereinafter, individual learning period) without integrating the weights of the shared parts of the respective recognition models, it is possible to improve the recognition accuracy before integration, particularly that with respect to the recognition task that is performed poorly, and to reduce the difference in recall.

In Equation (1), when the difference in the recalls with respect to the recognition task A and the recognition task B is greater than the threshold, the value of the integration cycle Tₙ increases and the individual learning period becomes longer. By integrating the weights of the shared parts of the recognition model A103 and the recognition model B108 after having lengthened the individual learning period, the integrated weight can be changed to a weight that enables both recognition tasks to be recognized in a more balanced manner.

Here, in the case where the difference in the recalls with respect to the recognition task A and the recognition task B is less than or equal to the threshold TH, learning is continued without changing the integration cycle Tₙ, but a configuration may be adopted in which learning is ended at the stage at which this difference in the recalls falls to less than or equal to the threshold TH.

Note that, in Equation (1), the integration cycle Tₙ is set according to the difference in the recalls, but a configuration may be adopted in which the integration cycle is set according to the recall with respect to the recognition task A or the recognition task B itself. For example, the setting unit 111 may increase the integration cycle Tₙ (e.g., by k such as in Equation (1)) when whichever is smaller of the recall with respect to the recognition task A and the recognition task B falls to is less than a predetermined recall.

The integration unit 112 integrates the weights corresponding to the shared parts of the recognition model A103 and the recognition model B108 at the timing of the integration cycle Tₙ set by the setting unit 111, and generates an integrated shared part. The integration unit 112 may integrate the weights of the recognition models by weighted average using the following Equation (2), for example.

$$\\ \begin{matrix}w = \frac{{α}_{A} \times {w}_{A} + {α}_{B} \times {w}_{B}}{{α}_{A} + {α}_{B}} & ( 2 )\end{matrix}$$

In Equation (2), w_{A} represents the weight of the shared part of the recognition model A103, w_{B} represents the weight of the shared part of the recognition model B108, and w represents the weight of the shared part integrated by weighted average. Also, α_{A} and α_{B} respectively represent the weighted average weights of the weighted average that are applied to the weights corresponding to the shared parts of the recognition model A103 and the recognition model B108. Here, the weighted average weights α_{A} and α_{B} are fixed at values freely determined by the user that implements learning, but a configuration may be adopted in which these weighted average weights are variables that are determined from the recalls with respect to the recognition task A and the recognition task B as shown in Equation (3).

$$\\ \begin{matrix}{α}_{A} = \frac{{Recall}_{all} - {Recall}_{A}}{{Recall}_{all}} & ( 3 )\end{matrix}$$

$$\\ {α}_{B} = \frac{{Recall}_{all} - {Recall}_{B}}{{Recall}_{all}}$$

$$\\ {Recall}_{all} = {Recall}_{A} + {Recall}_{B}$$

The integration unit 112 generates the part of the models corresponding to the shared parts that has the integrated weight as an integrated shared part. The update unit 113 replaces the shared part of each recognition model with the integrated shared part. Here, the update unit 113 performs the above-described replacement by updating the weight corresponding to the shared part of each recognition model with the weight of the integrated shared part. Note that there is no change in the layer structure of the network itself between the shared parts and the integrated shared part. The weights of the shared parts (weight parameters for use in characteristic operations) respectively acquired by the shared parts during learning are integrated at a timing described later, and the weight of the integrated shared part (weight parameter for use in characteristic operations) changes to an integrated parameter.

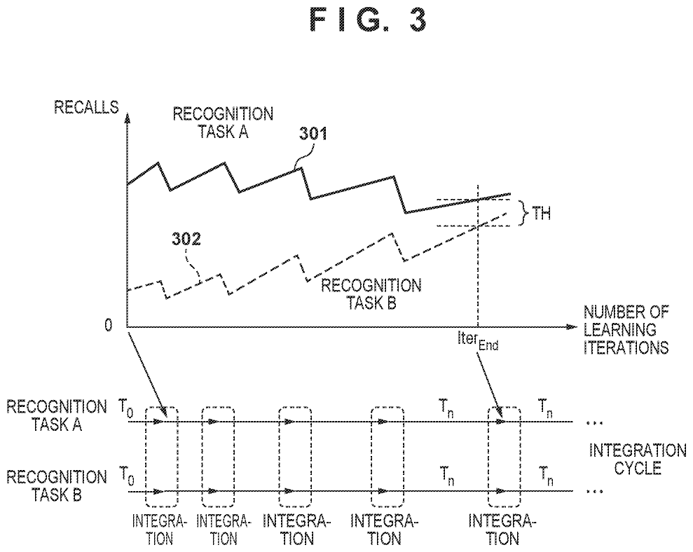

Distributed learning in which integration cycle setting processing and integration processing are performed by the setting unit 111, the integration unit 112 and the update unit 113 will now be described using FIG. 3. FIG. 3 shows an example of the transition in the recall of each recognition task with respect to the number of learning iterations. In the line graph (upper diagram) in FIG. 3, a solid line 301 is the transition in the recall with respect to the recognition task A, and a dashed line 302 is the transition in the recall with respect to the recognition task B. Learning iteration 0 is the timing at which learning is started. Furthermore, below the line graph (lower diagram), the individual learning period of the recognition tasks is indicated by the length of the arrows, and the timing for integrating and updating the weights corresponding to the shared parts of the recognition models is indicated by the dashed lines. The horizontal axis (number of learning iterations) is commonly referenced by the upper and lower diagrams of FIG. 3.

The initial integration cycle of the recognition task A and the recognition task B is T₀. In FIG. 3, the integration cycle is gradually lengthened, because the difference in the recalls with respect to the recognition task A and the recognition task B at learning iteration 0 is larger than the threshold TH. The individual learning period that is set to gradually lengthen is indicated by the length of the arrows indicating the individual learning periods of the recognition task A and the recognition task B in the lower diagram in FIG. 3.

When the integration cycle is lengthened, the recall with respect to the recognition task A decreases while the recall with respect to the recognition task B increases, and the difference therebetween is reduced. Regarding integration after the timing Iter_{End} at which the difference in recall falls below the threshold TH, learning is continued while maintaining the same integration cycle as the previous time.

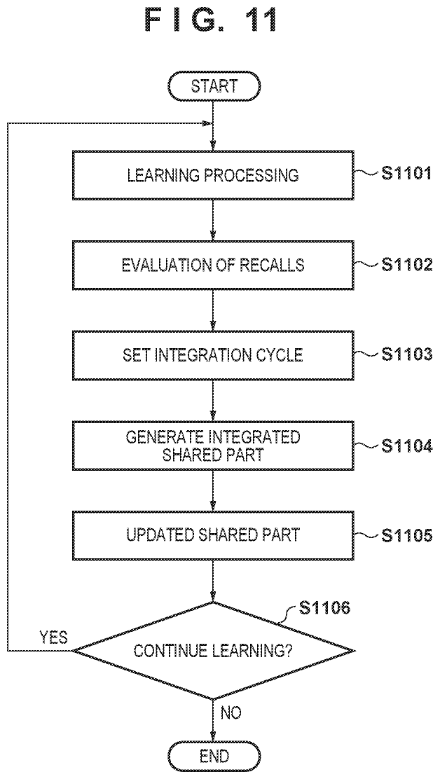

Next, processing for setting the integration cycle and integration processing of the recognition models by the information processing apparatus 1 will be described, with reference to FIG. 11. FIG. 11 is a flowchart showing an example of distributed learning processing that is performed by the information processing apparatus 1. Note that, in the following, processing relating to the recognition task A will be described, but it is assumed that similar processing relating to the recognition task B is also performed at the same time for each iteration of processing.

In step S1101, the learning unit A102 performs learning of the recognition model A103 for the integration cycle, using the learning data A101. In the case of the initial iteration of learning, the integration cycle is set to an initial value T₀ (e.g., 1000 iterations). If not the initial iteration of learning, the integration cycle set in step S1103 of the n−1th iteration of processing is used as the integration cycle, assuming that the current iteration of processing is the nth iteration.

In step S1102, the evaluation unit A104 evaluates the recognition accuracy of the recognition model A103 for which learning was performed in step S1101 with respect to the recognition task A. Here, recall is used as the recognition accuracy, and the evaluation of step S1102 is performed at the stage at which learning is iterated the integration cycle Tₙ number of times in step S1101, but the recognition accuracy may be evaluated at a predetermined cycle while the learning of step S1101 is in progress as described above.

In step S1103, the setting unit 111 sets an integration cycle Tₙ₊₁ for next performing integration of the shared parts, based on the difference between the recall with respect to the recognition task A and the recall with respect to the recognition task B that are evaluated in step S1102. In the present embodiment, the integration cycle is set based on Equation (1) described above.

In step S1104, the integration unit 112 integrates the weights corresponding to the shared parts of the recognition model A103 and the recognition model B108 for which learning was performed in step S1101, and generates an integrated shared part having an integrated parameter. In step S1105, the update unit 113 replaces the weight of the shared part of each recognition model with the weight (integrated parameter) of the integrated shared part, and reconstructs each recognition model.

In step S1106, the update unit 113 determines whether to continue the learning. In the case of ending the learning, the processing of FIG. 11 is ended, and, in the case of not ending the learning, the processing returns to step S1101. The condition for ending the learning may be freely set, and, for example, the update unit 113 may end the learning when the difference in the recalls used in step S1103 is less than or equal to the threshold as described above, or may end the learning when the loop of steps S1101 to S1106 is performed a predetermined number of times.

According to such a configuration, it becomes possible for the integration cycle at which weights corresponding to the shared parts of a plurality of recognition models that perform different recognition tasks are integrated to be set during learning. In particular, the recognition accuracies of the recognition models with respect to the recognition tasks can be evaluated, and the integration cycle can be set based on the difference in evaluation. Accordingly, the difference in the recalls with respect to the recognition task A and the recognition task B is reduced, and a detector that is able to recognize the recognition task A and the recognition task B in a balanced manner can be realized.

Note that, in the present embodiment, the case where there are two recognition tasks is described, but it is also possible to similarly set the integration cycle based on the difference in evaluation of recognition accuracy between recognition models, in the case where there are three or more recognition tasks. From the viewpoint of extending the individual learning period in order to improve recognition tasks that are performed poorly, the setting unit 111 may, for example, set the integration cycle based on the difference in the evaluations of the recognition accuracies with respect to the recognition task whose recognition accuracy evaluation is the lowest and the recognition task whose recognition accuracy evaluation is the highest, among the plurality of recognition tasks. Also, the setting unit 111 may, for example, set the integration cycle, based on the difference between the evaluation of the recognition accuracy with respect to the recognition task whose recognition accuracy evaluation is the lowest among the plurality of recognition tasks and a value (e.g., average value) that is calculated from the evaluations of the recognition accuracies with respect to the other recognition tasks. Also, the setting unit 111 may, for example, set the integration cycle, based on the difference between the evaluation of recognition accuracy with respect to the recognition task whose recognition accuracy evaluation is the highest among the plurality of recognition tasks and a value (e.g., average value) that is calculated from the evaluations of the recognition accuracies with respect to the other recognition tasks. In this way, the method of calculating the difference in the evaluations of the recognition accuracies with respect to a plurality of recognition tasks is not particularly limited, as long as the integration cycle is set to be longer in the case where the difference in the recognition accuracies with respect to the recognition tasks is evaluated to be large.

Note that, in each of the following embodiments, description will focus on the differences from the first embodiment, and it is assumed that the processing can be performed in a similar manner to the first embodiment unless stated otherwise.

### Second Embodiment

In the first embodiment, the difference in the recognition accuracies (recalls) with respect to the recognition task A and the recognition task B is evaluated as the difference in learning effect and the integration cycle is set based thereon, but the criterion for setting the integration cycle is not particularly limited thereto. In the second embodiment, the integration cycle is set based, not on the recognition accuracy of the first embodiment, but on a recognition result (particularly, the loss that is output by the recognition models) that differs from recognition accuracy.

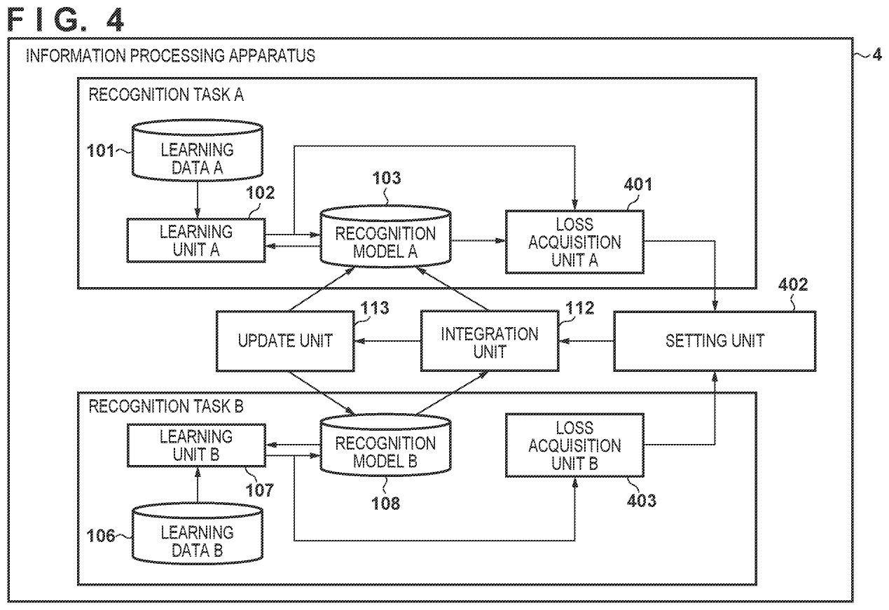

FIG. 4 is a block diagram showing an example of the functional configuration of an information processing apparatus 4 according to the present embodiment. The information processing apparatus 4 performs distributed learning that uses a recognition model A corresponding to a recognition task A and a recognition model B corresponding to a recognition task B. The information processing apparatus 4 has a similar configuration to the information processing apparatus 1 of the first embodiment, except for being provided with a loss acquisition unit A401 for the recognition task A instead of the evaluation unit A104 and the evaluation data A105, and being provided with a setting unit 402 instead of the setting unit 111. The configuration for the recognition task B is similar to that for the recognition task A, with the information processing apparatus 4 being provided with a loss acquisition unit B403 instead of the evaluation unit B109 and the evaluation data B110.

The loss acquisition unit A401 is able to acquire a value of the loss of the recognition model A instead of an evaluation of the recognition accuracy, at a similar timing to that at which the evaluation unit A104 acquires the evaluation of the recognition accuracy. Here, the loss acquisition unit A401 acquires the loss that is calculated by the learning unit A102 at a predetermined cycle and transmits the loss to the setting unit 402. The learning unit A102 is able to calculate the loss from the difference between the output of the recognition model A103 and the correct answer data of the learning data A101. In the loss calculation, an error sum of squares function, a cross entropy error function or the like is used as the loss function.

The setting unit 402 sets an integration cycle for integrating weights corresponding to the shared parts during learning, similarly to the setting unit 111. The setting unit 402 according to the present embodiment is able to set the integration cycle based on the difference in the losses of the recognition models with respect to the different recognition tasks.

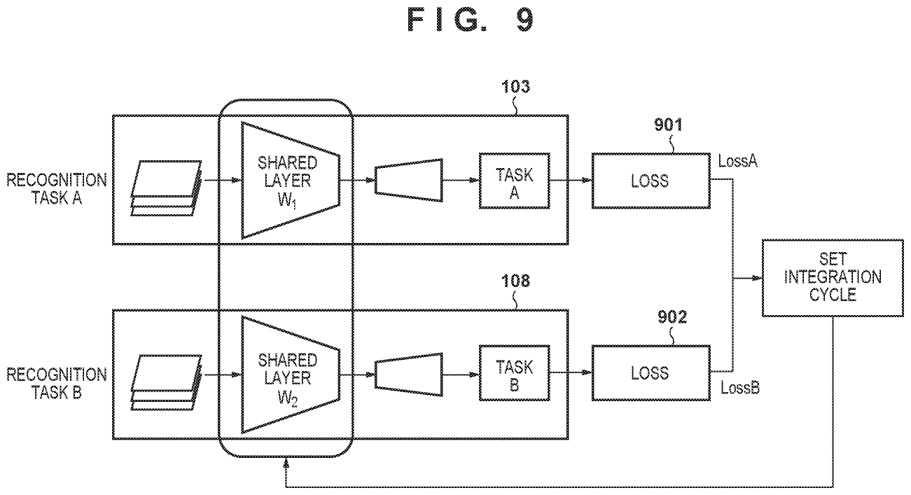

FIG. 9 is a schematic diagram of an example of integration cycle setting processing that is performed by the information processing apparatus 4 according to the present embodiment. In FIG. 9, the losses of the recognition models with respect to the recognition tasks are output, instead of the evaluation values (801, 802) that are output in FIG. 8. Here, the loss with respect to the recognition task A is output as a loss 901 (Loss_{A}), and the loss with respect to the recognition task B is output as a loss 902 (Loss_{B}). The setting unit 402 sets the integration cycle, based on these losses (e.g., based on Equation (4) described later), and replaces the shared layers (here, W₁, W₂) of the respective recognition models with a shared layer after integration at the set integration cycle. Hereinafter, the integration cycle setting processing that is performed by the setting unit 402 will be described.

The setting unit 402 is able to lengthen the integration cycle in the case where the difference in the losses of the recognition models exceeds a predetermined threshold. For example, the setting unit 402 sets the integration cycle for integration of the weights corresponding to the shared parts of the recognition model A103 and the recognition model B108 by the integration unit 112, based on the following Equation (4) that uses loss. Note that, here, the integration cycle is the number of learning iterations.

$$\\ \begin{matrix}{T}_{n} = \{ \begin{matrix}{T}_{n - 1} + k , \vert {Loss}_{A} - {Loss}_{B} \vert > TH \\ {T}_{n - 1} , otherwise\end{matrix} & ( 4 )\end{matrix}$$

Equation (4) is an equation for performing a similar calculation to Equation (1) except for using Loss_{A} and Loss_{B} instead of Recall_{A} and Recall_{B}. Loss_{A} represents the most recent loss with respect to the recognition task A, and Loss_{B} represents the most recent loss with respect to the recognition task B. Here, a threshold TH is a value freely determined by the user that implements learning, and, for example, |Loss_{A}−Loss_{B}| of the first iteration of learning may be calculated, and 50% of the calculated value may be set as TH. The increase k in the integration cycle is a value freely determined by the user that implements learning. The integration cycle at the time of performing the initial evaluation, that is, the integration cycle T₀ at n=0, is also a value freely determined by the user that implements learning.

In Equation (4), when the difference in the losses with respect to the recognition task A and the recognition task B is greater than the threshold, the value of the integration cycle Tₙ increases and the individual learning period becomes longer. By integrating the weights of the shared parts of the recognition model A103 and the recognition model B108 after having lengthened the individual learning period, the integrated weight can be changed to a weight that enables both recognition tasks to be recognized in a more balanced manner.

Note that, in Equation (4), the integration cycle Tₙ is set according to the difference in the losses, but the integration cycle may be set according to the loss with respect to the recognition task A or the recognition task B itself. For example, the setting unit 402 may increase the integration cycle Tₙ (e.g., by k such as in Equation (4)) when the greater of the loss with respect to one of the recognition task A and the recognition task B exceeds a predetermined loss.

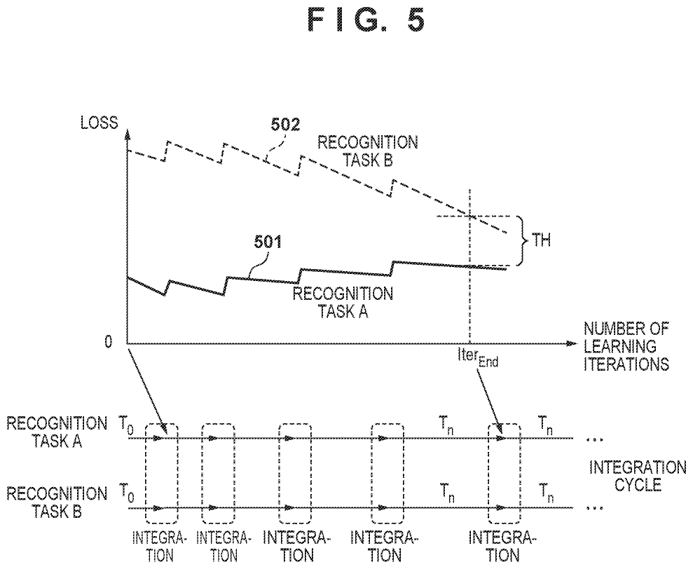

Distributed learning in which integration cycle setting processing and integration processing are performed by the setting unit 402, the integration unit 112 and the update unit 113 will now be described using FIG. 5. FIG. 5 shows an example of the transition in the losses with respect to each recognition task relative to the number of learning iterations. In the line graph (upper diagram) of FIG. 5, a solid line 501 is the transition in the loss with respect to the recognition task A, and a dashed line 502 is the transition in the loss with respect to the recognition task B. Learning iteration 0 is the timing at which learning is started. Furthermore, below the line graph (lower diagram), the individual learning period of the recognition tasks is indicated by the length of the arrows, and the timing for integrating and updating the weights corresponding to the shared parts of the respective recognition models is indicated by the dashed lines.

The horizontal axis (number of learning iterations) is commonly referenced by the upper and lower diagrams of FIG. 5.

The initial integration cycle of the recognition task A and the recognition task B is T₀. In FIG. 5, the integration cycle is gradually lengthened, because the difference in the losses with respect to the recognition task A and the recognition task B at learning iteration 0 is greater than the threshold TH. The individual learning period that is set to gradually lengthen is indicated by the length of the arrows indicating the individual learning periods of the recognition task A and the recognition task B in the lower diagram of FIG. 5.

When the integration cycle is lengthened, the loss with respect to the recognition task A increases while the loss with respect to the recognition task B decreases, and the difference therebetween is reduced. Regarding integrations after the timing Iter_{End} at which the difference in loss falls below the threshold TH, learning is continued while maintaining the same integration cycle as the previous time.

Note that the distributed learning processing by the information processing apparatus 4 according to the present embodiment is performed similarly to the processing of FIG. 11 except for acquiring the losses instead of the recalls in step S1102 and setting the integration cycle based on Equation (4) instead of Equation (1) in step S1103, and thus description thereof will be omitted.

According to such a configuration, the losses of a plurality of recognition models that perform different recognition tasks with respect to the recognition tasks can be evaluated, and the integration cycle can be set based on the difference in the losses thereof. Accordingly, the difference in the losses with respect to the recognition task A and the recognition task B is reduced, and a detector that is able to recognize the recognition task A and the recognition task B in a balanced manner can be realized.

### Third Embodiment

In the first and second embodiments, the difference in the recognition results (recalls or losses) with respect to the recognition task A and the recognition task B is evaluated as the difference in learning effect, and the integration cycle is set based thereon. In the third embodiment, the integration cycle is set based on the difference in the shared parts of the recognition models, instead of the recognition results of the first and second embodiments.

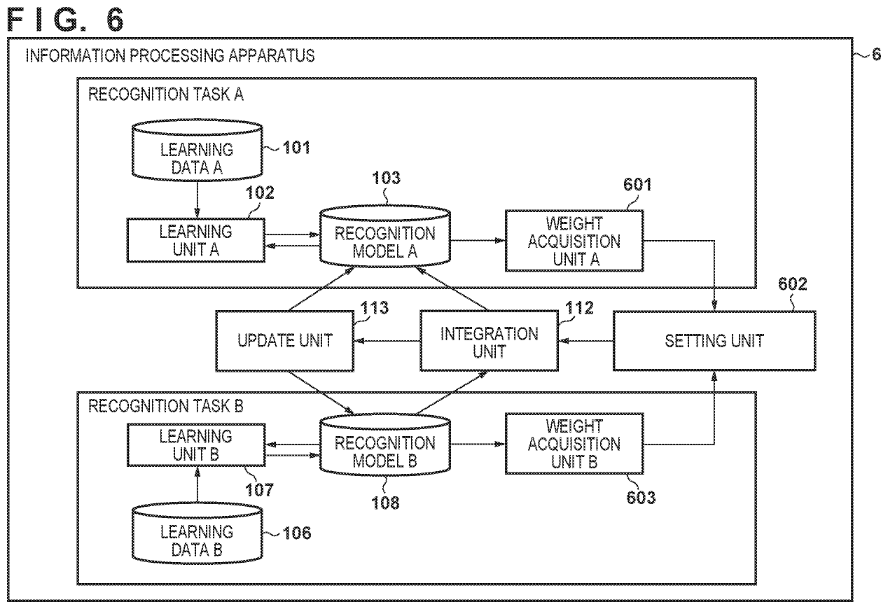

FIG. 6 is a block diagram showing an example of the functional configuration of an information processing apparatus 6 according to the present embodiment. The information processing apparatus 6 performs distributed learning that uses a recognition model A corresponding to a recognition task A and a recognition model B corresponding to a recognition task B. The information processing apparatus 6 has a similar configuration to the information processing apparatus 4 of the second embodiment, except for being provided with a weight acquisition unit A601 for the recognition task A instead of the loss acquisition unit A401, and being provided with a setting unit 602 instead of the setting unit 402. The configuration for the recognition task B is similar to that for the recognition task A, with the information processing apparatus 6 being provided with a weight acquisition unit B603 instead of the loss acquisition unit B403.

The weight acquisition unit A601 is able to acquire a weight corresponding to the shared part of the recognition model A instead of the loss, at a similar timing to that at which the loss acquisition unit A401 acquires the loss.

The setting unit 602 sets an integration cycle for integrating weights corresponding to the shared parts during learning, similarly to the setting unit 402. The setting unit 602 according to the present embodiment is able to set the integration cycle based on the difference in the weights of the recognition models, as the difference in the shared parts of the recognition models.

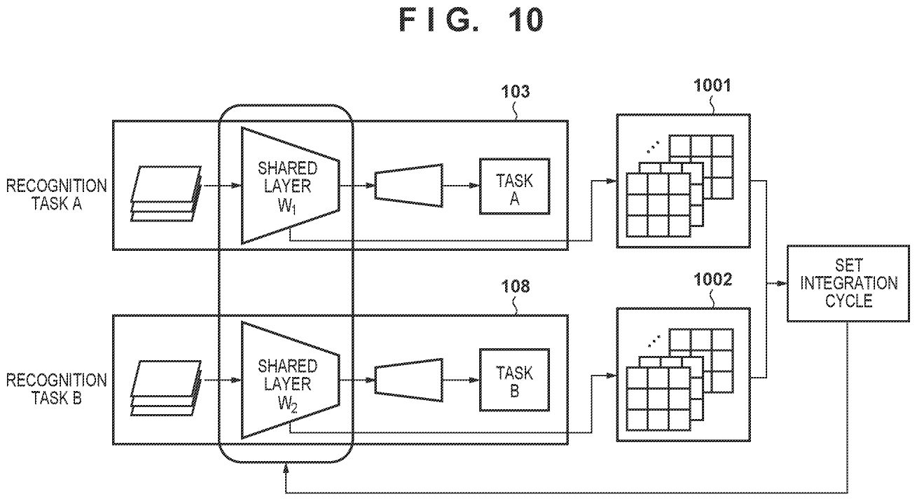

FIG. 10 is a schematic diagram of an example of integration cycle setting processing that is performed by the information processing apparatus 6 according to the present embodiment. In FIG. 10, the weights of the respective recognition models are output instead of the evaluation values (801, 802) that are output in FIG. 8. Here, the weight parameter of the recognition model A is output as a vector 1001, and the weight parameter of the recognition model B is output as a vector 1002. The setting unit 602 sets the integration cycle based on these weights (e.g., based on Equation (5) described later), and replaces the shared layers (here, W₁, W₂) of the respective recognition models with an integrated weight at the set integration cycle. Note that, in the present embodiment, the difference in the vectors of the weight parameters is evaluated using Lₚ norm, but a different method may be used as long as the difference in weight can be evaluated. Hereinafter, the integration cycle setting processing that is performed by the setting unit 602 will be described.

The setting unit 602 sets the integration cycle based on the difference in the weight vectors of the recognition models. For example, the setting unit 602 is able to lengthen the integration cycle in the case where the weight vectors satisfy the conditions shown in the following Equation (5). Note that, here, the integration cycle is the number of learning iterations.

$$\\ \begin{matrix}{T}_{n} = \{ \begin{matrix}{T}_{n - 1} + k , {‖ {W}_{A} - {W}_{B} ‖}_{p} < TH \\ {T}_{n - 1} , otherwise\end{matrix} & ( 5 )\end{matrix}$$

In Equation (5), w_{A} is a vector of the weight parameter corresponding to the shared part of the recognition model A103, W_{B} is a vector of the weight parameter corresponding to the shared part of the recognition model B108, TH is a threshold, and k is an increase in the integration cycle. Also, Tₙ is the integration cycle that is set this time (nth time), and Tₙ₋₁ is the integration cycle set last time. ∥∥p represents Lₚ norm. Here, the threshold TH is a value freely determined by the user that implements learning. For example, after the start of learning, ∥W_{B}−W_{A}∥p may be calculated from the weights of the shared layers of the recognition models immediately before the initial integration, and 200% of this value may be set as TH. The increase k in the integration cycle is a value freely determined by the user that implements learning. The integration cycle at the time of performing the initial evaluation, that is, the integration cycle T₀ at n=0, is also a value freely determined by the user that implements learning.

In Equation (5), when the difference in the weights of the shared layers of the recognition model A103 and the recognition model B108 is small, the value of the integration cycle Tₙ increases and the individual learning period becomes longer. By integrating the weights of the shared parts of the recognition model A103 and the recognition model B108 after having lengthened the individual learning period, the integrated weight can be changed to a weight that enables both recognition tasks to be recognized in a more balanced manner.

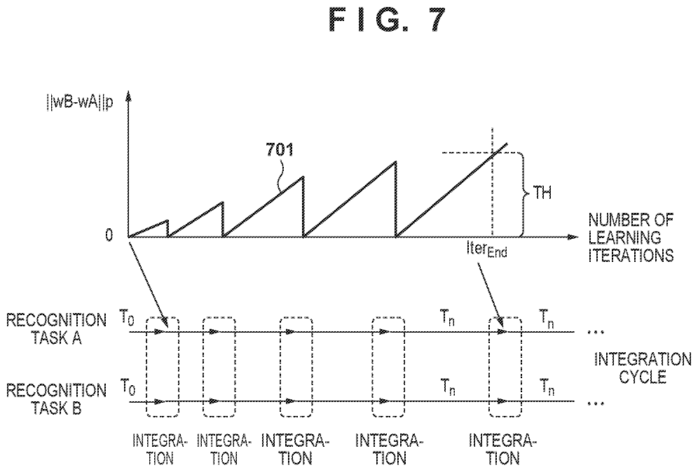

Distributed learning in which integration cycle setting processing and integration processing are performed by the setting unit 602, the integration unit 112 and the update unit 113 will now be described using the schematic diagram of FIG. 7. In the line graph of FIG. 7 (upper diagram), an example of the transition in the value of ∥W_{B}−W_{A}∥p relative to the number of learning iterations is shown by a solid line 701. Learning iteration 0 is the timing at which learning is started. Furthermore, below the line graph (lower diagram), the individual learning period of the recognition tasks is indicated by the length of the arrows, and the timing for integrating and updating the weights corresponding to the shared parts of the recognition models is indicated by the dashed lines. The horizontal axis (number of learning iterations) is commonly referenced by the upper and lower diagrams of FIG. 7.

The initial integration cycle of the recognition task A and the recognition task B is T₀. In FIG. 7, the integration cycle is gradually lengthened, because ∥W_{B}−W_{A}∥p at learning iteration 0 is less than the threshold TH. The individual learning period that is set to gradually lengthen is indicated by the length of the arrows indicating the individual learning periods of the recognition task A and the recognition task B in the lower diagram of FIG. 7. Regarding integrations after the timing Iter_{End} at which ∥W_{B}−W_{A}∥p exceeds the threshold TH, learning is continued while maintaining the same integration cycle as the previous time.

Note that the distributed learning processing by the information processing apparatus 6 according to the present embodiment is performed similarly to the processing of FIG. 11 except for acquiring the weight vectors instead of the recalls in step S1102 and setting the integration cycle based on Equation (5) instead of Equation (1) in step S1103, and thus description thereof will be omitted.

According to such a configuration, the integration cycle can be set based on the difference in the weights of a plurality of recognition models that perform different recognition tasks. Accordingly, ∥W_{B}-W_{A}∥p is increased, and a detector that is able to recognize the recognition task A and the recognition task B in a balanced manner can be realized.

### Fourth Embodiment

In the above-described embodiments, the processing units shown in FIG. 1 and the like, for example, are realized by dedicated hardware. Some or all of the processing units of the information processing apparatus 1 may be realized by a computer. In the present embodiment, at least some of the processing according to the above-described embodiments is executed by a computer.

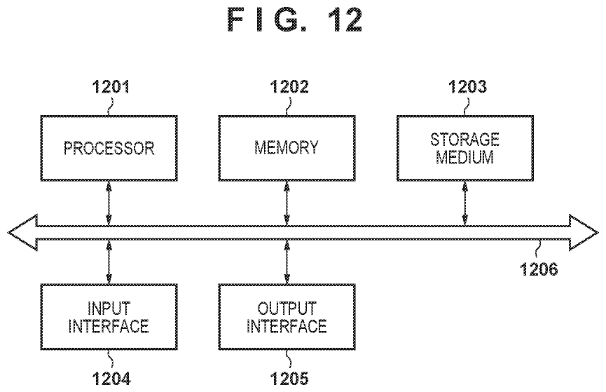

FIG. 12 is a diagram showing the basic configuration of a computer. In FIG. 12, a processor 1201 is a CPU, for example, and controls the operations of the entire computer. A memory 1202 is RAM, for example, and temporarily stores programs, data and the like. A computer-readable storage medium 1203 is a hard disk or a CD-ROM, for example, and stores programs, data and the like on a long-term basis. In the present embodiment, a program stored on the storage medium 1203 for realizing the functions of the various units is read out to the memory 1202. The functions of the various units are then realized by the processor 1201 operating in accordance with the program stored on the memory 1202.

In FIG. 12, an input interface 1204 is an interface for acquiring information from an external device. Also, an output interface 1205 is an interface for outputting information to an external device. A bus 1206 connects the above-described units and enables data exchange.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-013284, filed Jan. 31, 2023, which is hereby incorporated by reference herein in its entirety.

What is claimed is:

1. An information processing apparatus comprising one or more memories storing instructions and one or more processors that execute the instructions to:
perform, for each of a plurality of recognition models that perform different recognition tasks, learning using corresponding learning data;
reconstruct, during the learning, the plurality of recognition models by replacing weight parameters respectively acquired by shared parts of the recognition models with an integrated parameter obtained by integrating the weight parameters; and
set, during the learning, an integration cycle for performing the integration.

2. The information processing apparatus according to claim 1,
wherein the one or more processors execute the instructions to set the integration cycle, based on a difference in recognition results between the recognition models or a difference in the shared parts between the recognition models.

3. The information processing apparatus according to claim 2,
wherein the one or more processors execute the instructions to:
evaluate, during the learning, evaluation values of recognition accuracies of the plurality of recognition models with respect to the different recognition tasks, and
set the integration cycle, based on a difference in the evaluation values as the difference in the recognition results.

4. The information processing apparatus according to claim 3,
wherein the one or more processors execute the instructions to set the integration cycle to be longer than before setting, in a case where the difference in the evaluation values is greater than a first threshold.

5. The information processing apparatus according to claim 2,
wherein the one or more processors execute the instructions to:
acquire, during the learning, losses of the plurality of recognition models with respect to the different recognition tasks, and
set the integration cycle, based on a difference in the losses as the difference in the recognition results.

6. The information processing apparatus according to claim 5,
wherein the one or more processors execute the instructions to set the integration cycle to be longer than before setting, in a case where the difference in the losses is greater than a second threshold.

7. The information processing apparatus according to claim 2,
wherein the one or more processors execute the instructions to set the integration cycle, based on a difference in weight vectors of the shared parts as the difference in the shared part.

8. The information processing apparatus according to claim 7,
wherein the one or more processors execute the instructions to set the integration cycle to be longer than before setting, in a case where the difference in the weight vectors is less than a third threshold.

9. The information processing apparatus according to claim 2,
wherein the one or more processors execute the instructions to set the integration cycle, based on the difference in the recognition results between the recognition models at a timing of generating the integrated parameter or the difference in the shared parts between the recognition models.

10. The information processing apparatus according to claim 2,
wherein the one or more processors execute the instructions to set the integration cycle, based on the difference in the recognition results between the recognition models evaluated at a timing closest to a timing of generating the integrated parameter or the difference in the shared parts between the recognition models.

11. The information processing apparatus according to claim 1,
wherein the integration cycle is the number of iterations of the learning performed before the integration is performed.

12. The information processing apparatus according to claim 1,
wherein the one or more processors execute the instructions to generate the integrated parameter by integrating weights corresponding to the shared parts of the recognition models by weighted average.

13. An information processing method comprising:
performing, for each of a plurality of recognition models that perform different recognition tasks, learning using corresponding learning data;
reconstructing, during the learning, the plurality of recognition models by replacing weight parameters respectively acquired by shared parts of the recognition models with an integrated parameter obtained by integrating the weight parameters; and
setting, during the learning, an integration cycle for performing the integration.

14. A non-transitory computer readable storage medium storing a program that, when executed by a computer, causes the computer to perform an information processing method comprising:
performing, for each of a plurality of recognition models that perform different recognition tasks, learning using corresponding learning data;
reconstructing, during the learning, the plurality of recognition models by replacing weight parameters respectively acquired by shared parts of the recognition models with an integrated parameter obtained by integrating the weight parameters; and
setting, during the learning, an integration cycle for performing the integration.
